(19) United States
(12) Patent Application Publication
(10) Pub. No.: US 2025/0304190 A1
(43) Pub. Date: Oct. 2, 2025

(54) FAIRING DEVICE AND METHODS OF FORMING A FAIRING DEVICE

(71) Applicant: DAIMLER TRUCK NORTH AMERICA LLC, Portland, OR (US)

(72) Inventors: Sascha LANGHEIN, Portland, OR (US); Mushaf NAZEER, Bangalore (IN); Naveen JOEL, Portland, OR (US); Riley JACK, Portland, OR (US); Jonathan GUZMAN, Portland, OR (US)

(21) Appl. No.: 19/092,593

(22) Filed: Mar. 27, 2025

Related U.S. Application Data
(60) Provisional application No. 63/571,214, filed on Mar. 28, 2024.

(51) Int. Cl. B62D 35/00; B29C 45/26

(52) U.S. Cl. CPC B62D 35/001; B29C 45/263

(57) ABSTRACT

A fairing device includes a first support element having a first end and a second end. A second support element is positioned proximate to the first end of the first support element. A structure couples the first support element to the second support element and supports the first support element with respect to the second support element to form the fairing device. A method of forming the fairing device using a molding process is also disclosed.

This application claims the benefit of U.S. Provisional Patent Application Ser. No. 63/571,214, filed Mar. 28, 2024, which is hereby incorporated by reference in its entirety.

### BACKGROUND

Fairings are often employed on vehicles to improve aerodynamic performance. Fairings are generally employed as part of an assembly having a number of connected parts that must be assembled together. These assemblies are prone to degradation in the field. Specifically, the forces to which the assembly is subjected may cause one or more of the components to degrade. Further, typical assemblies are heavy and not stiff enough to reach a high frequency value which could increase durability. The present application is directed to overcoming these and other deficiencies in the art.

### SUMMARY

One aspect of the present disclosure relates to a fairing device. The fairing device includes a first support element having a first end and a second end. A second support is positioned proximate to the first end of the first support element. A structure couples the first support element to the second support element and supports the first support element with respect to the second support element to form the fairing device.

Another aspect of the present disclosure relates to a method of forming a fairing device. The method includes inserting a first support element into a mold when the mold is in an open position, the mold configured to generate a structure. A shapeable material is inserted into the mold. A second support element is formed from the shapeable material by applying a force to the shapeable material during movement of the mold to a closed position. A plastic material is injected into the mold when the mold is in the closed position to form the structure from the plastic material. The fairing device is removed from the mold. The molded structure couples the first to the second support element and supports the first support element with respect to the second support element to form the fairing device.

Another aspect of the present disclosure relates to a fairing device for a vehicle. The fairing device includes a structure overmolded on a first support element and a portion of a second support element to form the fairing device.

Yet another aspect of the present disclosure relates to a method for forming a fairing device. The method includes overmolding a structure on first support element and a portion of a second support element, thereby forming the fairing device.

The present disclosure provides a fairing device that is a lightweight component that can be formed using a “one shot” manufacturing process. The fairing device advantageously has higher durability as compared to prior art fairing assemblies due to the structural integration and higher stiffness. Further, the fairing device is advantageously formed as a single device with no further assembly required, no secondary operations for manufacture, and no joining parts.

### BRIEF DESCRIPTION OF THE DRAWINGS

FIG. 1 is a schematic of an exemplary fairing device, according to an aspect of the present disclosure.

FIG. 2A is an isometric view of an exemplary fairing device, according to an aspect of the present disclosure.

FIG. 2B is another isometric view of the exemplary fairing device shown in FIG. 2A, according to an aspect of the present disclosure.

FIG. 2C is a side view of the exemplary fairing device shown in FIG. 2A, according to an aspect of the present disclosure.

FIG. 2D is an end view of exemplary fairing device shown in FIG. 2A, according to an aspect of the present disclosure.

FIG. 3 is an image of an exemplary textured surface for a fairing device, according to an aspect of the present disclosure.

FIG. 4 is a flowchart of an exemplary method for forming a fairing device, according to an aspect of the present disclosure.

FIG. 5A is a schematic view of a molding system including a molding tool during a step in the exemplary method of FIG. 4, according to an aspect of the present disclosure.

FIG. 5B is an isometric phantom view of the molding tool during the step shown in FIG. 5A, according to an aspect of the present disclosure.

FIG. 5C is a block diagram of an exemplary control system for use with the molding system shown in FIG. 5A.

FIG. 5D is a block diagram of an exemplary controller of the control system shown in FIG. 5C.

FIG. 6A is a schematic view of the molding tool during another step in the exemplary method of FIG. 4, according to an aspect of the present disclosure.

FIG. 6B is an isometric phantom view of the molding tool during the step shown in FIG. 6A, according to an aspect of the present disclosure.

FIG. 6C is an isometric view of the molding tool during the step shown in FIG. 6A that illustrates insertion of a shapeable material into the molding tool, according to an aspect of the present disclosure.

FIG. 7A is schematic view of the molding tool during another step in the exemplary method of FIG. 4, according to an aspect of the present disclosure.

FIG. 7B is an isometric phantom view of the molding tool during the step shown in FIG. 7A, according to an aspect of the present disclosure.

FIG. 8 is schematic view of the molding tool during another step in the exemplary method of FIG. 4, according to an aspect of the present disclosure.

FIG. 9 is schematic view of the molding tool during another step in the exemplary method of FIG. 4, according to an aspect of the present disclosure.

FIG. 10A is schematic view of the molding tool during another step in the exemplary method of FIG. 4, according to an aspect of the present disclosure.

FIG. 10B is an isometric phantom view of the molding tool and formed fairing device during the step shown in FIG. 10A, according to an aspect of the present disclosure.

### DETAILED DESCRIPTION

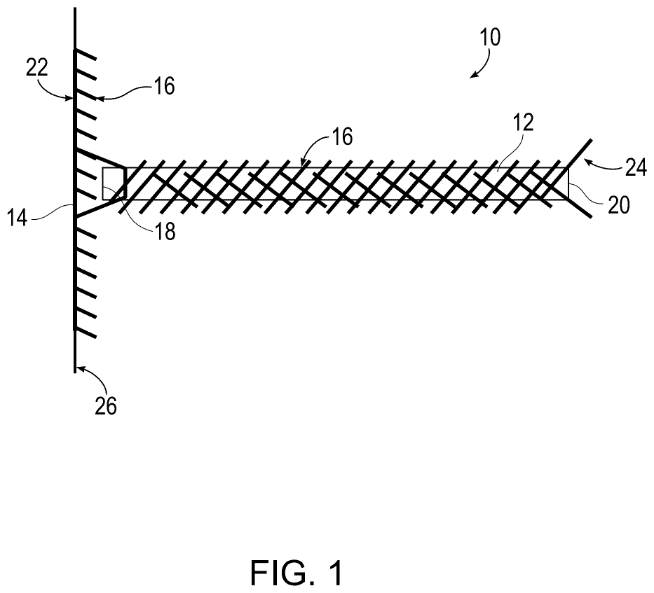

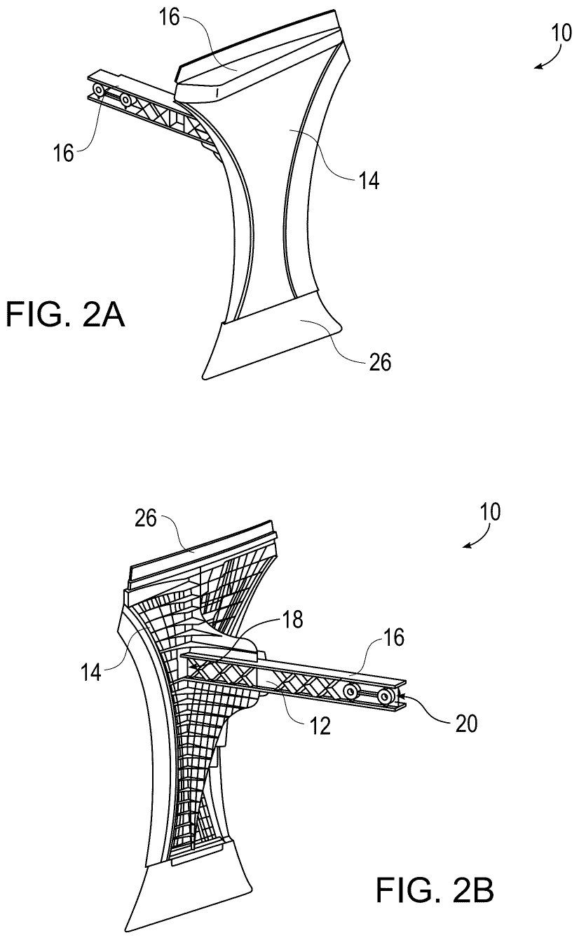

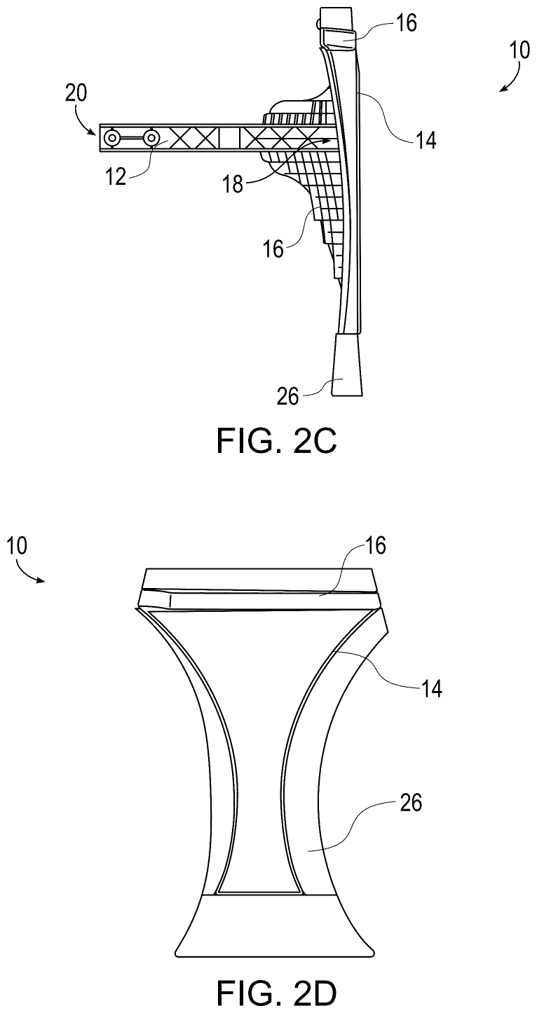

FIGS. 1 and 2A-2D illustrate an exemplary fairing device 10 including first support element 12, a second support element 14, and a structure 16 that is overmolded onto the first support element 12 and the second support element 14 to connect and support the elements with respect to one another, although the fairing device 10 can include other types and/or numbers of elements in other combinations. Although first support element 12 and second support element 14 are illustrated and described, it is to be understood that other support elements could be utilized in other combinations. Structure 16 is overmolded onto the first support element 12 and the second support element 14 to form the fairing device 10 as a single unit, i.e., there is no assembly required prior to installing the fairing device 14. The fairing device 10 is adapted, for example, to couple to a vehicle to provide improved aerodynamic performance. Improved aerodynamic performance can, in turn, advantageously reduce total energy consumption over time, amongst other advantages. The fairing device 10 can be utilized for large vehicles that are commonly seen pulling cargo trailers on highways, and which are generally referred to as “semis,” “18-wheelers,” “tractor trailers,” “commercial vehicles,” and the like, although the fairing device 10 can be employed on other types and/or sizes of vehicles. The fairing device 10 can be employed for helping to direct air flow around the wheels, or other components of the vehicle.

The fairing device 10 advantageously provides a lightweight component that can be formed using a “one shot” manufacturing process, as described in further detail below. Due to the combined injection molding and forming process, the fairing device 10 is stiffer, and much more durable, while being substantially lighter (e.g., 10-20 percent lighter in some examples), than fairing assemblies produced via other approaches. Further, the fairing device 10 is formed as a single device with no further assembly required, no secondary operations for manufacture, and no joining parts, which leads to cycle time reduction. Other advantages include but are not limited to robustness and resistance to degradation, including degradation stemming from adverse operating conditions (e.g., snow, sleet, mud, ill-maintained roads, and the like). Still further, the fairing device 10 provides an overall lower part cost due to less material usage and waste than otherwise used in conjunction with prior art fairing assemblies.

Referring again to FIGS. 1 and 2A-2D, generally, the first support element 12 extends between a first end 18 and a second end 20. In some examples, the first support element 12 is configured to attach to a vehicle at the second end 20 and supports the second support element 14 at the first end 18. In some examples, the first support element 12 is configured to be bolted, clinched, riveted, or screwed, to the vehicle at the second end 20, although and any other form of attachment may be employed. In one example, the first support element 12 is formed of a metal material, such as an extruded aluminum, although other suitable materials, such as a hard plastic, can be utilized for the first support element 12. In one example, the first support element 12 has one or more features located on a surface thereof for receiving portions of the structure 16 therein during the molding process, as described in further detail below. In one example, the first support element 12 has an open channel profile, such as a c-shaped, double T-shape, or an l-shaped profile, although any other shape could be employed for the profile of the first support element 12. In other examples, the arm 14 has a closed channel profile, such as a hollow cylinder, a hollow cube, etc.

The second support element 14 is positioned proximate to the first end 18 of the first support element 12. In one example, the second support element 14 is formed of a shapeable material. In some examples, the shapeable material can be an organo sheet. As used herein, the term “organo sheet” refers to any continuous fiber reinforced thermoplastic sheet containing primarily carbon or glass fiber fabrics. In additional or alternative examples, other shapeable materials can be utilized for the second support element 14. The second support element 14 is coupled to the first support element 12 by the structure 16, as described in further detail below, such that the first support element 12 is supported with respect to the second support element 14. The second support element 14 can be formed with a variety of shapes during the molding process, as described in further detail below, depending on the application. For example, a leading edge of the second support element 14 may be straight or curved and an outer surface 22 of the second support element 14 may be flat, angled or curved outward, angled or curved inward or some combination thereof to promote desired aerodynamic flow. In some examples, the second support element 14 may have a symmetric design to fit either side of the vehicle in a desired position, including positions that are angled inward or outward.

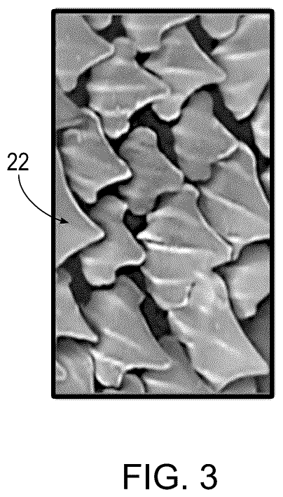

The outer surface 22 of the second support element 14 is configured to direct fluid (e.g., air or water) flow in a desired manner. In one example, the outer surface 22 directs fluid flow in a rearward angle such as straight back, back and out, or back and in, when installed on a vehicle. Outer surface 22 forms an aerodynamic surface that provides attached flow for longitudinal air flow (air flow streaming back as the vehicle moves forward) and can direct flow in a longitudinal angle such as parallel to the longitudinal axis of the vehicle, primarily back and inwards or primarily back and outwards. The outer surface 22 can be textured to improve the aerodynamic performance. In one example, the outer surface 22 itself is textured during the fairing device manufacturing process. For example, the outer surface 22 can have a shark skin texture such as illustrated in FIG. 3, by way of example, although other textures, such as other textures that apply biomimicry (e.g., feather-like texture, can be employed to improve aerodynamic performance of the second support element 14. In another example, a textured material, such as a textured film having the texture on a surface thereof, can be applied to the outer surface 22 of the second support element 14, such as through an adhesive to adhesively attach outer surface 22 to the second support element 14.

Structure 16 is overmolded on the first support element 12 and the second support element 14 to form the fairing device 10, as described in further detail below. The structure 16 couples the first support element 12 to the second support element 14 and supports the first support element 12 with respect to the second support element 14. The structure 16 substantially surrounds the first support element 12. In one example, the structure 16 is formed from a plastic material, such as a thermoplastic, although other materials such as thermoset materials, polymer-metal hybrids, or polymer-polymer hybrids could be employed. The structure 16 can extend into one or more features on the first support element 12 or features located along the edges of the second support element 14 to secure the structure 16 thereto. As shown in FIG. 1, the structure 16 in some examples can form a bracket 24 located near the second end 18 of the first support element 12 to allow for coupling the fairing device 10 to a vehicle. For example, the bracket 24 can be configured to allow the first support element 12 fairing device 10 to be bolted, clinched, riveted, or screwed, to the vehicle at the second end 18 of the first support element 12 associated with fairing device 10, through the bracket 24.

Referring again to FIGS. 1 and 2A-2D, in some examples, the fairing device 10 can optionally include a flexible material 26, such as a plastic, elastomer or thermoplastic-elastomer blend, or thermoplastic. Natural rubbers and polymer in general may be employed including those formed from sustainable resources. In examples, flexible material 26 may be located at the edges (e.g., outer edges) of the second support element 14. As described in further detail below, the flexible material 26 can be overmolded onto the second support element 14 using a two-component injection molding process.

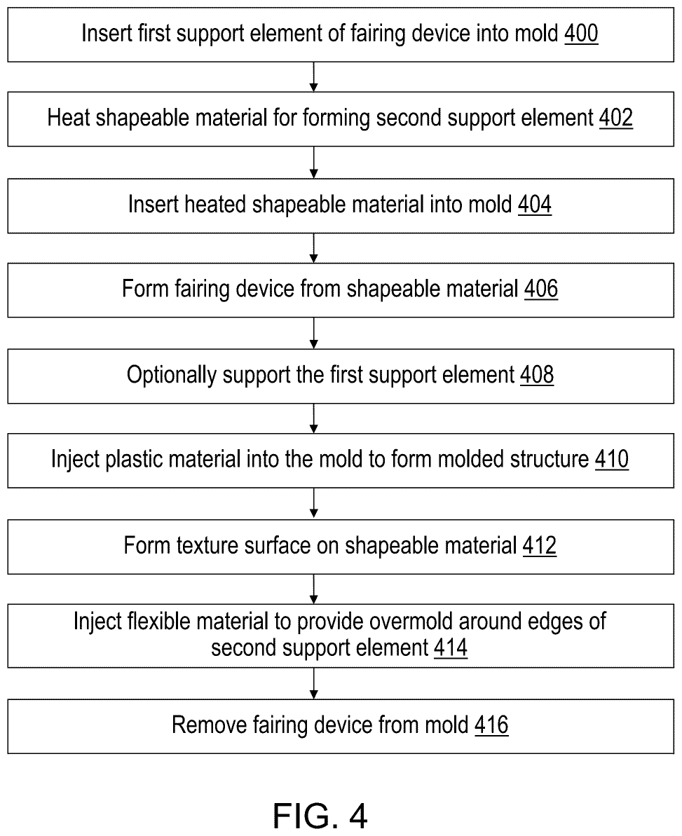

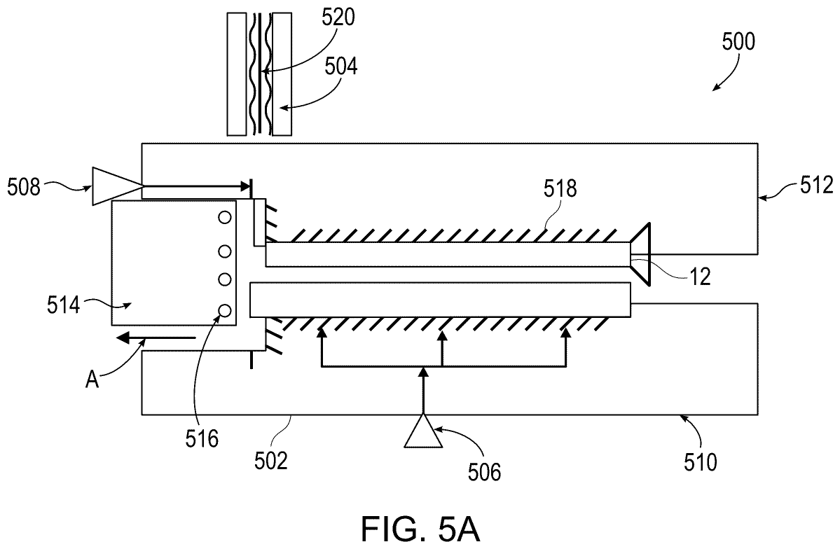

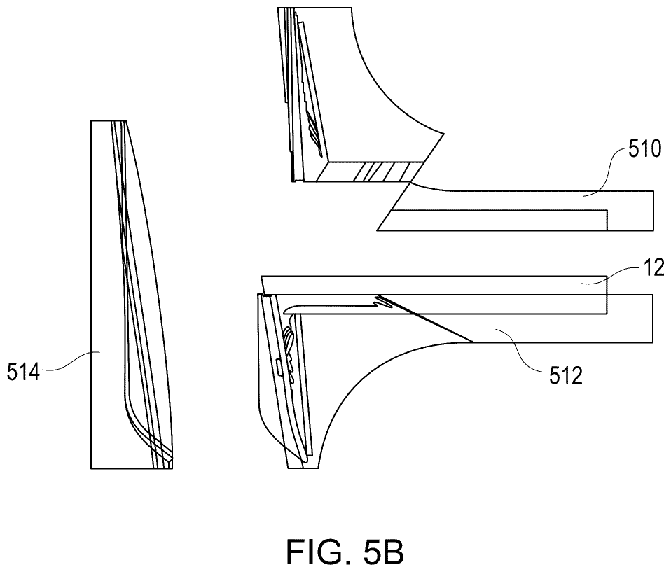

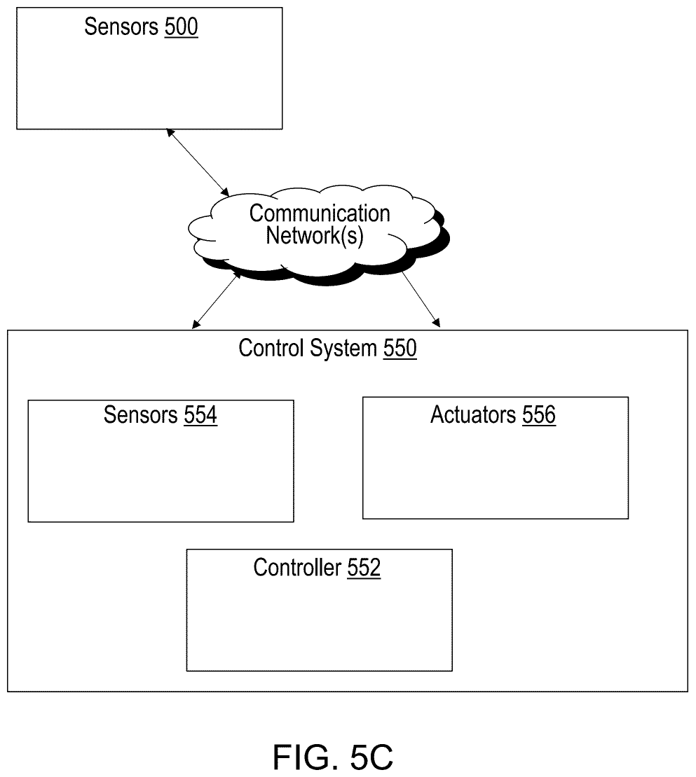

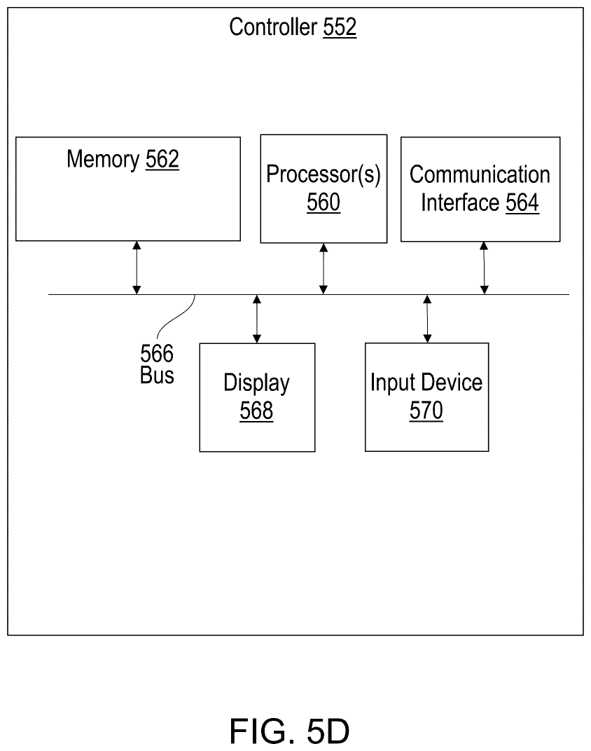

Referring now to FIGS. 4-10B, an exemplary method for forming a fairing device, such as the fairing device 10 shown in FIGS. 1 and 2A-2D, will be described. The method is described with respect to the system 500 shown, for example, in FIG. 5A, although it is to be understood that the elements of system 500 are exemplary and the method could be performed using other suitable systems. Further, the system can include other elements that are typically found in injection molding systems.

Referring again to FIG. 5A, by way of example, the system 500 includes a molding apparatus 502, an infrared oven 504, a primary plasticizing unit 506, and an optional secondary plasticizing unit 508, although the system 500 can include other types and/or numbers of elements or devices in other combinations. The molding apparatus 502 can made up of several moveable parts that can be moved with respect to one another during the molding operation. In this example, the molding apparatus 502 includes a core side 510 (sometimes referred to as a fixed side), a cavity side 512 (sometimes referred to as a movable side), and a slider or lifter 514, although the molding apparatus 502 can include other elements such as additional sliders or lifters. The slider or lifter 514 further includes an inductor and/or cooling channel 516 that is used to heat and cool a surface of the slider 514 during operation of the molding apparatus 502. The elements of the molding apparatus 502 include recessed features 518 therein that allow for injection molding the structure 16 over the first support element 12 and the second support element 14 in a “one shot” molding process as described in further detail below. The recessed features 518 can be varied to adjust the shape or features of the structure 16 as known in the art of injection molding. Optional overmold inserts can be placed into the mold to allow for a second component molding process using the secondary plasticizing unit 508, for example.

In some examples, the system 500 can be controlled in an automated fashion via a control system 550 including a controller 552, sensors 554, and actuators 556, by way of example. Although the sensors 554 and actuators 556 are illustrates as part of the control system 550, it is to be understood that the sensors 554 and actuators 556 can be associated with any of the elements of the system 500 in various combinations.

The sensors 554 can be any type of sensors known in the art to provide data to the controller 552 regarding aspects of the system 500, such as position of the moveable parts of the molding apparatus 502 or any of the operations of the elements 500 during the molding process, including the infrared oven 504, the primary plasticizing unit 506, and the optional secondary plasticizing unit 508. Any types and/or numbers of sensors known in the art of injection molding may be included in the control system 550. Actuators 556 can be any type of actuators known in the art for moving the moveable parts, mechanical devices (e.g., plasticizing units), heating elements, etc., of the molding apparatus 502. Actuators 556 can be controlled by the controller 552, for example. In examples, the actuators 556 can be any known actuators in the art configured to move the moveable parts of the molding apparatus 502 with various degrees of freedom.

FIG. 5D is a block diagram of an exemplary controller 552 of the control system 550. The controller 552 may be employed for providing instructions to any of the elements of system 500 to provide automated control of the molding processes described herein. The controller 552 in this example includes one or more processor(s) 560, a memory 562, and a communication interface 564, which are coupled together by a bus 566, although the controller 552 can include other types or numbers of elements in other configurations, such as a display screen 568 or an input device 570.

The processor(s) 560 of the controller 552 may execute programmed instructions stored in the memory 562 of the controller 552 for any number of the functions identified herein. The processor(s) 560 of the controller 552 may include one or more central processing units (CPUs) or general purpose processors with one or more processing cores, for example, although other types of processor(s) can also be used. In examples, the controller 552 executes programmed instructions stored in memory 562, to carry out the method 400 at FIG. 4.

The memory 562 of the controller 552 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 562.

Accordingly, the memory 562 of the controller 552 can store one or more modules that can include computer executable instructions that, when executed by the controller 552, cause the controller 552 to perform actions described herein. The modules can be implemented as components of other modules. Further, the modules can be implemented as applications, operating system extensions, plugins, or the like.

Even further, the modules may be operative in a cloud-based computing environment. The modules can be executed within or as virtual machine(s) or virtual server(s) that may be managed in a cloud-based computing environment. Also, the modules, and even the controller 552 itself, may be located in virtual server(s) running in a cloud-based computing environment rather than being tied to one or more specific physical network computing devices. Also, the modules may be running in one or more virtual machines (VMs) executing on the controller 552. Additionally, in one or more examples of this technology, virtual machine(s) running on the controller 552 may be managed or supervised by a hypervisor. In this particular example, the memory 562 of the controller 552 includes instructions for controlling the system 500 to provide any of the molding operations described herein.

The communication interface 564 of the controller 552 operatively couples and communicates between the controller 552, sensors 554, actuators 556, and any of the elements of the system 500, which are coupled together at least in part by one or more communication network(s). By way of example only, the communication network(s) can include local area network(s) (LAN(s)) or wide area network(s) (WAN(s)), and can use TCP/IP over Ethernet and industry-standard protocols, although other types or numbers of protocols or communication networks can be used. The communication network(s) in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

Controller 552 may run services and/or interface applications, such as standard web browsers or the standalone applications, which may provide an interface to communicate with sensors 554, actuators 556, and any of the elements of the system 500 via the communication interface 564. Controller 552 may further include a display device, such as a display screen 568 or touchscreen, or an input device 570, such as a keyboard or mouse, for example. Display screen 568 and/or input device 570 can be used to monitor, modify, or program any aspects of system 500. While the controller 552 is illustrated in this example as including a single device, the controller 552 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the controller 552.

Additionally, one or more of the devices that together comprise the controller 552 in other examples can be standalone devices or integrated with one or more other devices or apparatuses, such as one or more of the server devices, for example. Moreover, one or more of the devices of the controller 552 in these examples can be in a same or a different communication network including one or more public, private, or cloud networks, for example.

Referring now to FIGS. 4, 5A, and 5B, in step 400, the first support element 12 (as shown for example in FIG. 1) is inserted into the molding apparatus 502 when the molding apparatus 502 is an open position, as shown in FIGS. 5A and 5B. In the open position, the core side 510, cavity side 512, and slider/lifter 514 are moved apart from one another to accommodate the first support element 12 within the molding apparatus 502. In this example, core side 510 moves away from the cavity side 512 and the slider moves in direction A, although other methods could be employed to open the molding apparatus 502.

In one example, at step 400 of the method of FIG. 4, the first support element 12 inserted into the molding apparatus 502 is formed of a metal material, such as an extruded aluminum, although other suitable materials, such as a hard plastic, can be utilized for the first support element 12. In one example, the first support element 12 has one or more features, such as grooves, channels, or holes, located on a surface along an axis thereof for receiving portions of the molded structure therein during the molding process. These features create a physical bonding between the first support element 12 and the structure 16 (FIG. 1) when formed. In one example, the first support element 12 has an open channel profile, such as a c-shaped, double T-shaped, or an l-shaped profile, although other shape profiles can be employed. In other examples, the arm 14 has a closed channel profile, such as a hollow cylinder. The use of a closed channel profile may require additional steps during the injection molding process, such as the optional step 408 as described below.

In step 402, a shapeable material 520 is heated in the infrared oven 504, as shown in FIG. 5A, prior to being inserted into the molding apparatus 502, although other heating apparatuses can be employed. The shapeable material 520 is used to form the second support element 14 of the fairing device 10 (as shown for example in FIG. 1). Heating the shapeable material 520 allows for the second support element 14 to be formed with a variety of shapes with various contours during the molding process, as described in further detail below, depending on the application.

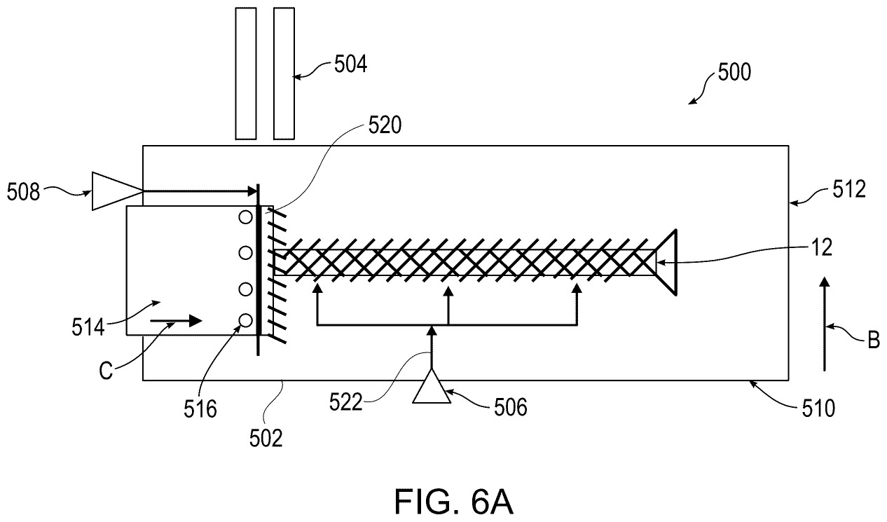

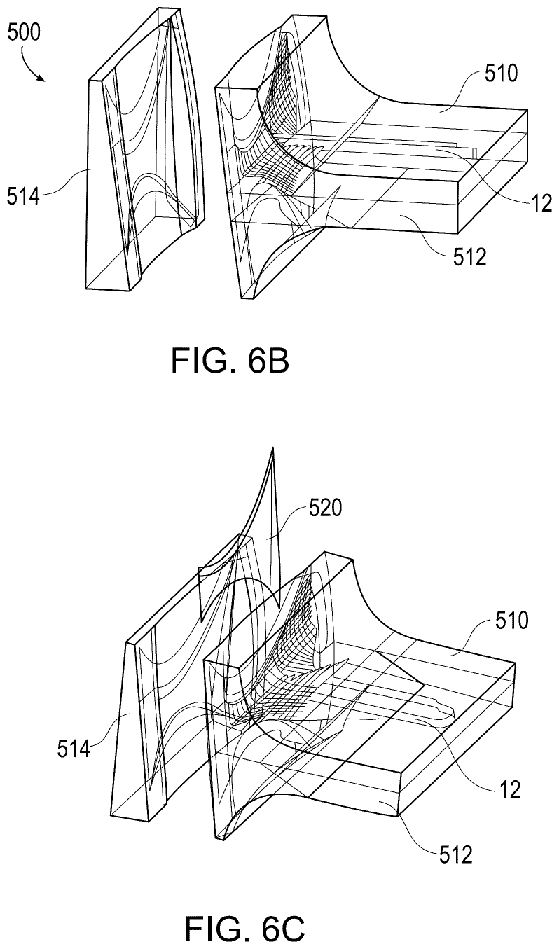

Referring now to FIGS. 4 and 6A-6C, in step 404, the shapeable material 520, once heated, is inserted into the molding apparatus 502. The shapeable material 520 can be inserted while the molding apparatus 502 is closing. As shown in FIGS. 6A-6C, the core side 510 is moved in direction B with respect to the cavity side 512 to close the molding apparatus 502 around the first support element 12. The slider 514 can then be operated to form the second support element 14 from the shapeable material 520.

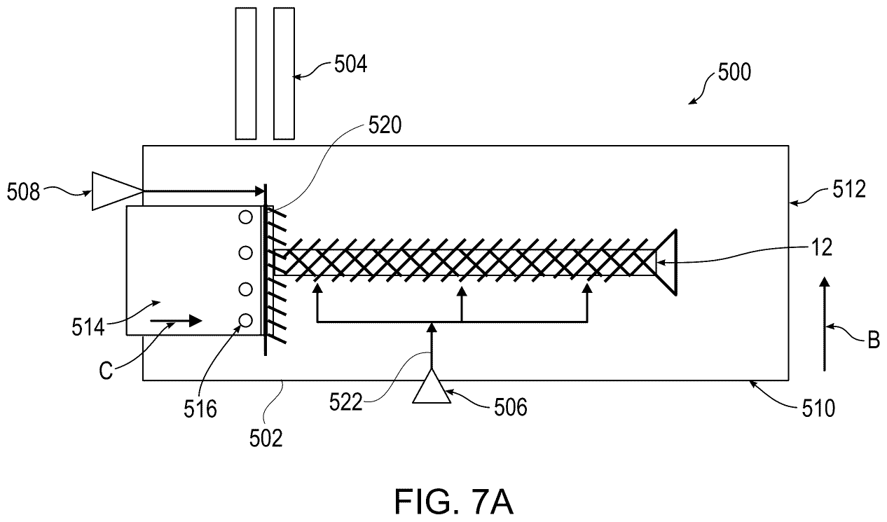

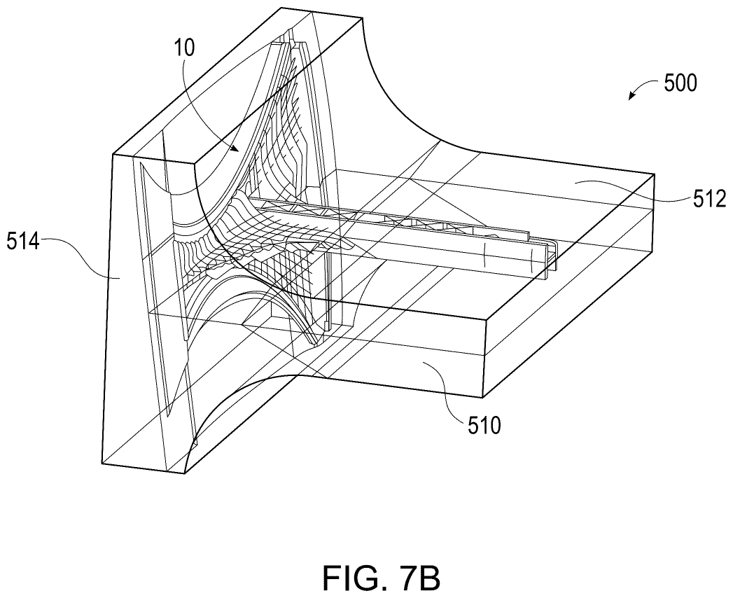

Referring now to FIGS. 4, 7A, and 7B, next, in step 406, the second support element 14 is formed from the shapeable material 520 by applying a force to the shapeable material 520 during movement of the molding apparatus 502 to a closed position. Specifically, the slider/lifter 514 moves in direction C, as shown in FIG. 6A to push the shapeable material 520 against the core side 510 and the cavity side 512 to form the heated shapeable material 520 to the desired shape for the second support element 14. For example, a leading edge of the second support element 14 may be straight or curved and an outer surface 22 of the second support element 14 may be flat, angled or curved outward, angled or curved inward or some combination thereof to promote desired aerodynamic flow. In some examples, the second support element 14 may have a symmetric design to fit either side of the vehicle in a desired position, including positions that are angled inward or outward, although other shapes can be achieved by modifying the structure of the molding apparatus 502.

Optional step 408 is employed when the first support element 12 has a closed channel profile, such as a hollow tube or hollow cube, etc. In step 408, hydroforming is employed for the closed channel profile prior to the injection molding to equalize pressure and to avoid the closed channel profile from collapsing during the injection molding, although other techniques known in the art of injection molding may be employed, such as gas assisted forming.

In step 410, a material 522 suitable for forming the structure 16, such as a plastic, is injected into the molding apparatus 502 using the primary plasticizing unit 506. The injection molding is performed with the molding apparatus 502 in the closed position as shown in FIGS. 7A and 7B. The injected material enters the recessed features 518 in the molding apparatus 502 to form the structure 16. Packing and cooling of the structure 16 also starts at this stage and is performed continuously throughout the molding process.

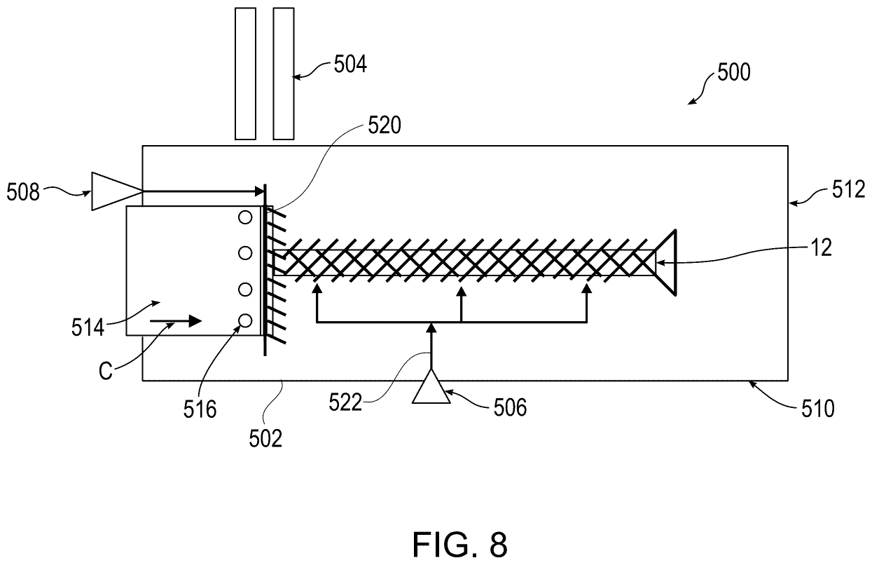

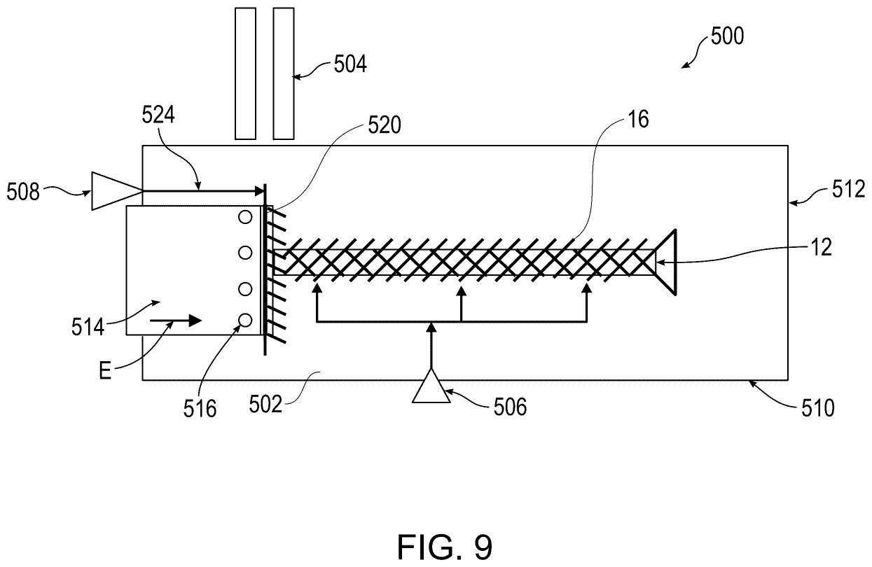

Referring now to FIGS. 4 and 8, in step 412, a textured surface, such as the surface 22 shown in FIG. 3, is formed on the shapeable material 520. In this example, the slider 514 has a positive profile on a surface thereof that is pushed into the shapeable material 520 to form a negative profile that provides the textured surface. The slider 514 moves in direction D to push against the shapeable material 520, such as an organo sheet in some examples, while the molding apparatus 502 is in the closed position, as shown in FIG. 8. For example, the slider 514 can move approximately 0.05 mm to about 1 mm (in one example, the slider 514 moves about 0.2 mm) into the shapeable material 520 to form the textured surface. Although the direction D is described, it is to be understood that the slider 514 could have other degrees of freedom to move with respect to the shapeable material 520 to form the textured surface. The inductor and cooling channel 516 is used to heat the surface of the shapeable material 520 to allow for imparting the textured surface thereon. Once the textured surface is formed, induction heating stops and the slider 514 is returned along direction E to the injection molding position shown in FIG. 9, for example. Cold water is employed in the inductor and cooling channel 516 to cool the surface of the slider 514. Packing of both the primary and second plasticizing units 506 and 508 stops at this stage.

Referring now to FIGS. 4 and 9, in optional step 414, a flexible material 524 is injection molded using the secondary plasticizing unit 508. The flexible material 524 provides an overmold around one or more edges of the second support element 14. In one example, optional step 414 is performed substantially simultaneously with step 412.

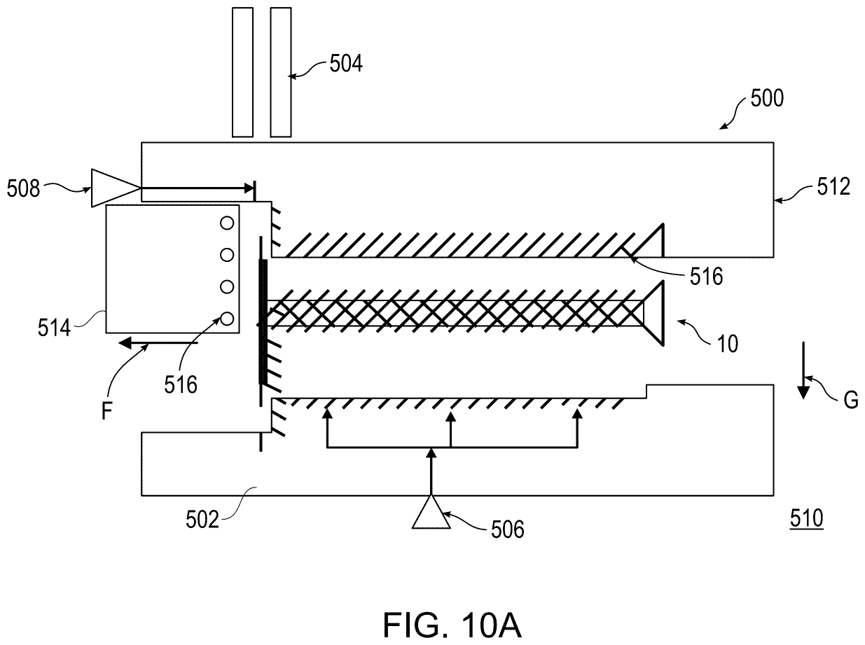

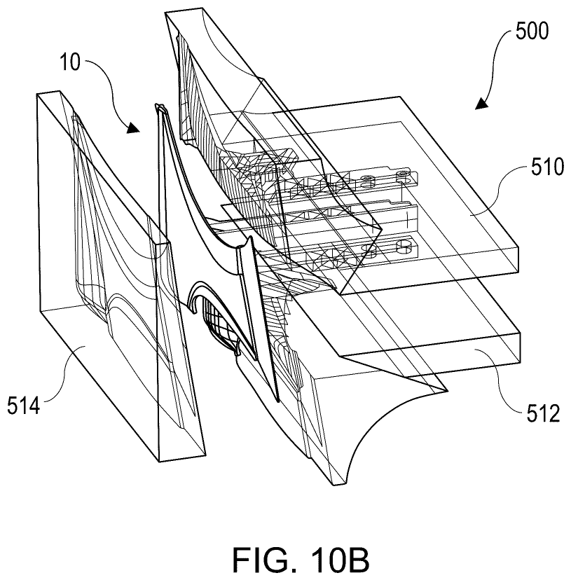

In step 416, the fairing device 10 is removed from the molding apparatus 502. In this step, as shown in FIG. 10A, the slider 514 moves in direction F to return to the original position shown in FIG. 5A, for example. The core side 510 moves in direction G to open the molding apparatus 502. The fairing device 10 can then be ejected from the molding apparatus 502 as a fully formed unit with no further assembly required. The structure 16 is overmolded on the first support element 12 and the second support element 14 to form the fairing device 10. The structure 16 couples the first support element 12 to the second support element 14 and supports the first support element 12 with respect to the second support element 14. The structure 16 substantially surrounds the first support element 12. As shown in FIG. 10A, the structure 16 in some examples can form a bracket 24 located near the second end 20 of the first support element 12 to allow for coupling the fairing device 10 to a vehicle.

The technology described herein can further be implemented by any of the following numbered clauses:

Clause 1: A fairing device comprising: a first support element having a first end and a second end; a second support element positioned proximate to the first end of the first support element; and a structure configured to couple the first support element to the second support and to support the first support element with respect to the second support element to form the fairing device.

Clause 2: The fairing device of Clause 1, wherein the second support element is formed from a shapeable material.

Clause 3: The fairing device of Clause 2, wherein the shapeable material has a textured surface.

Clause 4: The fairing device of Clause 3, wherein the textured surface is formed within the shapeable material.

Clause 5: The fairing device of Clause 3, wherein the textured surface is adhesively attached to the shapeable material.

Clause 6: The fairing device of any of the preceding Clauses, wherein the first support element is formed of a metal material or a reinforced plastic material.

Clause 7: The fairing device of Clause 6, wherein the first support element is an aluminium extrusion.

Clause 8: The fairing device of any of the preceding Clauses, wherein the first support element has one or more features on a surface thereof for receiving portions of the structure therein.

Clause 9: The fairing device of any of the preceding Clauses, wherein the first support element has an open channel profile.

Clause 10: The fairing device of Clause 9, wherein the first support element is c-shaped, double T-shaped, or l-shaped.

Clause 11: The fairing device of any of the preceding Clauses, wherein the first support element has a closed channel profile.

Clause 12: The fairing device of any of the preceding Clauses, wherein the structure is formed from a plastic material.

Clause 13: The fairing device of any of the preceding Clauses further comprising: a flexible material around one or more edges of the second support element.

Clause 14: The fairing device of Clause 13, wherein the flexible material is a plastic.

Clause 15: The fairing device of any of the preceding Clauses, wherein the structure provides a bracket located at the second end of the first support element.

Clause 16: The fairing device of any of the preceding Clauses, wherein the structure substantially surrounds the first support element.

Clause 17: A method of forming a fairing device, the method comprising: inserting a first support element into a mold when the mold is an open position; inserting a shapeable material into the mold; forming a second support element from the shapeable material by applying a force to the shapeable material during movement of the mold to a closed position; injecting a plastic material into the mold when the mold is in the closed position to form a structure from the plastic material; and removing the fairing device from the mold, wherein the structure couples the first support element to the second support element and supports the first support element with respect to the second support element to form the fairing device.

Clause 18: The method of Clause 17, wherein the first support element has one or more features on a surface thereof for receiving portions of the structure therein.

Clause 19: The method of Clause 17 or Clause 18, wherein the first support element has a closed channel profile, the method further comprising: supporting the closed channel profile prior to injecting the plastic material into the mold.

Clause 20: The method of any one of Clauses 17 through 19, wherein the shapeable material comprises an organo sheet.

Clause 21: The method of any one of Clauses 17 through 20 further comprising: heating the shapeable material prior to inserting the shapeable material into the mold.

Clause 22: The method of any one of Clauses 17 through 21 further comprising: forming a textured surface on the shapeable material using the mold while the mold is in the closed position.

Clause 23: The method of any one of Clauses 17 through 22 further comprising: injection molding a flexible material to provide an overmold around one or more edges of the second support element.

Clause 24: The method of any one of Clauses 17 through 23, wherein the fairing device is generated using a single injection molding step.

Clause 25: The method of any one of Clauses 17 through 24, wherein the mold comprises a cavity side, a core side, and a slider device.

Clause 26: The method of Clause 25, wherein the force applied to the shapeable material during movement of the mold to the closed position is provided by the slider device pushing the shapeable material against the cavity side and the core side.

Clause 27: The method of Clause 25 or Clause 26 further comprising: forming a textured surface on the shapeable material by pushing the slider device against the shapeable material while the mold is in the closed position.

Clause 28: The method of any one of Clauses 17 through 27, wherein the shapeable material is inserted into the mold while the mold is closing.

Clause 29: A fairing device for a vehicle comprising: a structure overmolded on a first support element and a portion of a second support element to form the fairing device.

Clause 30: The fairing device of Clause 29, wherein the second support element is formed from a shapeable material.

Clause 31: The fairing device of Clause 30, wherein the shapeable material has a textured surface.

Clause 32: The fairing device of Clause 31, wherein the textured surface is formed within the shapeable material.

Clause 33: The fairing device of Clause 31, wherein the textured surface is adhesively attached to the shapeable material.

Clause 34: The fairing device of any one of Clauses 29 through 33, wherein the first support element is formed of a metal material or a reinforced plastic material.

Clause 35: The fairing device of Clause 34, wherein the first support element is an aluminium extrusion.

Clause 36: The fairing device of any one of Clauses 29 through 35, wherein the first support element has one or more features on a surface thereof for receiving portions of the structure therein.

Clause 37: The fairing device of any one of Clauses 29 through 36, wherein the first support element has an open channel profile.

Clause 38: The fairing device of Clause 37, wherein the first support element is c-shaped, double T-shaped, or l-shaped.

Clause 39: The fairing device of any one of Clauses 29 through 38, wherein the first support element has a closed channel profile.

Clause 40: The fairing device of any one of Clauses 29 through 39, wherein the structure is formed from a plastic material.

Clause 41: The fairing device of any one of Clauses 29 through 40further comprising: a flexible material around one or more edges of the second support element.

Clause 42: The fairing device of Clauses 41, wherein the flexible material is a plastic.

Clause 43: The fairing device of any one of Clauses 29 through 42, wherein the structure provides a bracket located at the second end of the first support element.

Clause 44: The fairing device of any one of Clauses 29 through 42, wherein the structure substantially surrounds the first support element.

Clause 45: A method for forming a fairing device, comprising: overmolding a structure on first support element and a portion of a second support element, thereby forming the fairing device.

Clause 46: The method of claim 45 further comprising: inserting the first support element into a mold when the mold is an open position; inserting a shapeable material into the mold; forming the second support element from the shapeable material by applying a force to the shapeable material during movement of the mold to a closed position; injecting a plastic material into the mold when the mold is in the closed position to form the structure from the plastic material; and removing the fairing device from the mold, wherein the structure couples the first support element to the second support element and supports the first support element with respect to the second support element to form the fairing device.

Clause 47: The method of Clause 45 or Clause 46, wherein the first support element has one or more features on a surface thereof for receiving portions of the structure therein.

Clause 48: The method of any one of Clauses 45 through 47, wherein the first support element has a closed channel profile, the method further comprising: supporting the closed channel profile prior to injecting the plastic material into the mold.

Clause 49: The method of any one of Clauses 45 through 48, wherein the shapeable material comprises an organo sheet.

Clause 50: The method of any one of Clauses 45 through 49 further comprising: heating the shapeable material prior to inserting the shapeable material into the mold.

Clause 51: The method of any one of Clauses 45 through 50 further comprising: forming a textured surface on the shapeable material using the mold while the mold is in the closed position.

Clause 52: The method of any one of Clauses 45 through 51 further comprising: injection molding a flexible material to provide an overmold around one or more edges of the second support element.

Clause 53: The method of any one of Clauses 45 through 52, wherein the fairing device is generated using a single injection molding step.

Clause 54: The method of any one of Clauses 45 through 53, wherein the mold comprises a cavity side, a core side, and a slider device.

Clause 55: The method of Clause 54, wherein the force applied to the shapeable material during movement of the mold to the closed position is provided by the slider device pushing the shapeable material against the cavity side and the core side.

Clause 56: The method of Clause 54 or Clause 55 further comprising: forming a textured surface on the shapeable material by pushing the slider device against the shapeable material while the mold is in the closed position.

Clause 57: The method of any one of Clauses 45 through 56, wherein the shapeable material is inserted into the mold while the mold is closing.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A fairing device comprising:
a first support element having a first end and a second end;
a second support element positioned proximate to the first end of the first support element; and
a structure configured to couple the first support element to the second support and to support the first support element with respect to the second support element to form the fairing device.

2. The fairing device of claim 1, wherein the second support element is formed from a shapeable material.

3. The fairing device of claim 1, wherein the first support element is formed of a metal material or a reinforced plastic material.

4. The fairing device of claim 1, wherein the first support element has one or more features on a surface thereof for receiving portions of the structure therein.

5. The fairing device of claim 1, wherein the first support element has an open channel profile.

6. The fairing device of claim 1, wherein the first support element has a closed channel profile.

7. The fairing device of claim 1, wherein the structure is formed from a plastic material.

8. The fairing device of claim 1, wherein the structure is overmolded onto the first support element and the second support element.

9. The fairing device of claim 1 further comprising:
a flexible material around one or more edges of the second support element.

10. The fairing device of claim 1, wherein the structure provides a bracket located at the second end of the first support element.

11. A method of forming a fairing device, the method comprising:
inserting a first support element into a mold when the mold is an open position;
inserting a shapeable material into the mold;
forming a second support element from the shapeable material by applying a force to the shapeable material during movement of the mold to a closed position;
injecting a plastic material into the mold when the mold is in the closed position to form a structure from the plastic material; and
removing the fairing device from the mold, wherein the structure couples the first support element to the second support element and supports the first support element with respect to the second support element to form the fairing device.

12. The method of claim 11, wherein the first support element has one or more features on a surface thereof for receiving portions of the structure therein.

13. The method of claim 11, wherein the first support element has a closed channel profile, the method further comprising:
supporting the closed channel profile prior to injecting the plastic material into the mold.

14. The method of claim 11, wherein the shapeable material comprises an organo sheet.

15. The method of claim 11 further comprising:
heating the shapeable material prior to inserting the shapeable material into the mold.

16. The method of claim 11 further comprising:
forming a textured surface on the shapeable material using the mold while the mold is in the closed position.

17. The method of claim 11 further comprising:
injection molding a flexible material to provide an overmold around one or more edges of the second support element.

18. The method of claim 17, wherein the fairing device is generated using a single injection molding step.

19. The method of claim 17, wherein the mold comprises a cavity side, a core side, and a slider device, wherein the force applied to the shapeable material during movement of the mold to the closed position is provided by the slider device pushing the shapeable material against the cavity side and the core side.

20. The method of claim 19 further comprising:
forming a textured surface on the shapeable material by pushing the slider device against the shapeable material while the mold is in the closed position.
